(19) United States
(12) Patent Application Publication
(10) Pub. No.: US 2007/0160729 A1
(43) Pub. Date: Jul. 12, 2007

(54) CAPSINOID-CONTAINING DRIED CHILI PEPPER PRODUCT AND METHOD OF DRYING THE SAME

(75) Inventors: Hideki MORI, Kawasaki-shi (JP); Tomoko Hirano, Kawasaki-shi (JP); Hiroshi Kuhara, Kawasaki-shi (JP); Akira Okada, Kawasaki-shi (JP); Satoshi Yamahara, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJIMOTO CO. INC., Tokyo (JP)

(21) Appl. No.: 11/611,330

(22) Filed: Dec. 15, 2006

Related U.S. Application Data
(63) Continuation of application No. PCT/JP05/11196, filed on Jun. 13, 2005.

(30) Foreign Application Priority Data
Jun. 15, 2004 (JP) 2004-176936

(51) Int. Cl. A47J 39/00

(52) U.S. Cl. 426/520; 426/615

(57) ABSTRACT

Drying capsinoid-containing chili peppers for capsinoid extraction, such that hot drying is conducted so that, at a minimum, the weight of the capsinoid-containing chili peppers is reduced to not more than 20 percent, and the moisture content to not more than 10 percent, of that of the raw fruit, is useful for obtaining a stable product.

### CROSS REFERENCES TO RELATED APPLICATIONS

This application is a continuation of International Patent Application No. PCT/JP2005/011196, filed on Jun. 13, 2005, and claims priority to Japanese Patent Application No. 176936/2004, filed on Jun. 15, 2004, both of which are incorporated herein by reference in their entireties.

### BACKGROUND OF THE INVENTION

1. Field of the Invention

The present invention relates to capsinoid-containing dried chili pepper products and to methods for preparing the same.

2. Discussion of the Background

As a chili pepper with little pungency, the non-pungent species ∓CH-19 Sweet” that has been selectively fixed by Yazawa et al. contains almost none of the pungent, invasive capsaicinoid compounds (capsaicin, dihydrocapsaicin, and the like) of common chili peppers. However, it is reported to contain large quantities of novel, non-pungent capsinoid compounds (fatty acid esters of vanillyl alcohol, capsiates, dihydrocapsiates, and the like) (see, Japanese Patent Application Publication No. Heisei 11-246478). Further, these capsinoid compounds have been identified in other plants of the genus Capsicum (see, Journal of the Japanese Society for Horticultural Science, vol. 58, pp. 601-607).

Although capsinoid compounds differ from capsaicinoid compounds by being non-pungent, they are reported to have energy-metabolizing effects, body fat accumulation-inhibiting effects, immunostimulating activity and the like (see, Japanese Patent Application Publication No. Heisei 11-246478). Future applications are thus anticipated.

Since the molecular structure of the capsinoid compounds contains ester bonds, they are unstable in the presence of water. They are also characterized by decomposing extremely readily in the presence of heat. Accordingly, the efficient extraction of capsinoid compounds from chili peppers presents the practical problem of how to prevent decomposition of the capsinoid compounds in the various steps through extraction.

Japanese Patent Application Publication No. Heisei 11-246478 describes a method of drying capsinoid-containing plants characterized in that a freeze-drying method is employed before a capsinoid extraction step. However, the freeze-drying method is inadequately efficient at the level of large-quantity industrial production. Japanese Patent Application Publication No. 2001-69938 discloses a method for manufacturing dried chili peppers and a device for the same. However, this patent relates to a method for drying common hot chili peppers; there is no particular problem with the stability of capsaicins, which are the main components of hot chili peppers. Generally, there are numerous known methods with regard to dryers and mechanisms suitable for use on foods as a whole (see, Japanese Patent Application Publication No. 2000-41613; Osamu SAKASHITA, Methods of Scaling-Up Powder Plants, p. 153; Handbook of Powder Technology, comp. by Tsunemi MORI, p. 206; and Powder Engineering Handbook, 2^{nd} ed., comp. by the Japan Society of Powder Technology, p. 358). However, no drying method of any type has yet been disclosed that takes into account the stability of the above-described capsinoid compounds.

Thus, there remains a need for a method of drying which is free of the above-mentioned drawbacks.

### SUMMARY OF THE INVENTION

Accordingly, it is one object of the present invention to provide novel capsinoid-containing compositions.

It is another object of the present invention to provide novel method methods of preparing such compositions.

It is another object of the present invention to permit the stable and industrial extraction of capsinoids and their use as powder formula in foods, and more particularly, to discover suitable drying conditions that prevent the decomposition of capsinoid compounds and increase the yield in the step of drying capsinoid-containing chili peppers prior to the extraction of capsinoid compounds.

Specifically, it is another object of the present invention to provide a method for conveniently drying capsinoid-containing chili pepper while maintaining stability of capsinoids under prescribed conditions, and to provide a capsinoid-containing dried chili pepper product.

These and other objects, which will become apparent during the following detailed description, have been achieved by the inventors' discovery that cutting capsinoid-containing chili peppers—either in advance or during drying—and then subjecting them to a (continued) drying step increased the surface area and ruptured the outer skin of the chili peppers, thereby accelerating the evaporation of internal moisture, enhancing the drying efficiency, and permitting rapid drying. They also discovered that a combination of frequent and uniform mixing and stirring caused moisture to evaporate evenly from the chili pepper mass, preventing uneven heating. Still further, they discovered that during hot air drying, maintaining the speed of the hot air passing through the capsinoid-containing chili pepper mass at about 0.3 m/s or more when averaged in batches, or about 0.2 m/s or more when continuously averaged, yielded excellent results. As a result, it was discovered that excessive heating of capsinoid components was prevented and thus the decomposition of capsinoid compounds was suitably prevented during the drying step. The present invention was devised on this basis. Further, as a result of various research focused on drying conditions and stirring conditions in the drying step, the present inventors discovered conditions that better prevented the decomposition of capsinoid compounds. The present invention was also devised on this basis.

That is, the present invention relates to methods for drying capsinoid-containing chili peppers and to capsinoid-containing dried chili pepper products.

Thus, the present invention provides the following:

(1) A method for drying a material to be dried in the form of capsinoid-containing chili peppers by means of a box-type batch dryer, wherein the capsinoid survival rate following drying is 70 percent or greater, comprising:

1) charging the material to be dried into the dryer so that the material comes into contact with hot air; and

2) setting an airflow so that an average speed of hot air immediately after passing through the material to be dried is 0.3 m/s or more, with a speed of hot air not being so great as to scatter the material to be dried; and conducting drying until a moisture content as measured by AOAC method is 10 percent or less.

(2) A method for drying material to be dried in the form of capsinoid-containing chili peppers in a continuous dryer, wherein the survival rate of capsinoids following drying is 70 percent or greater, comprising:

1) charging the material to be dried into the dryer so that the material to be dried comes into contact with hot air; and

2) setting an airflow so that an average speed of hot air immediately after passing through the material to be dried is 0.2 m/s or more, with a speed of hot air not being so great as to scatter the material to be dried; and drying until a moisture content as measured by AOAC method is 10 percent or less.

(3) The method according to (1) or (2) wherein said drying method satisfies at least one of the following conditions:

1) a hot air temperature of 65 to 80° C.; or

2) stirring of the material conducted at least once per hour.

(4) The method according to any one of (1) to (3) wherein said material to be dried has been sliced to a width of 0.5 to 10 mm.

(5) The drying method according to any one of (1) to (4) wherein said capsinoid-containing chili peppers are one or more chili peppers selected from the group consisting of Manganji peppers, Shishito peppers, Fushimi Amanaga peppers, and CH-19 Sweet peppers.

(6) A method for drying capsinoid-containing chili peppers for use in the extraction of capsinoids, characterized in that heat drying is conducted so that, at a minimum, the weight of the capsinoid-containing chili peppers is reduced to not more than 20 percent, and the moisture content to not more than 10 percent, of that of the raw fruit.

(7) The drying method according to (6) wherein said drying method is conducted with a dryer having a heat transfer system operating based on a method selected from the group consisting of convective heat transfer, conductive heating, and radiative heat transfer, or a combination of such methods, and wherein the dryer operates continuously or in batches.

(8) The drying method according to (7) wherein said dryer is classified as a band-type, fluidized bed-type, draft-type, rotating-type, spraying-type, stirring-type, box-type, moving bed-type, or drum-type dryer based on the mechanical configuration thereof.

(9) The drying method according to any one of (6) to (8) wherein said drying method is implemented with a convective heat-transfer type dryer and either continuous or discontinuous stirring is conducted at least once an hour.

(10) The drying method according to any one of (6) to (9) wherein said drying method is implemented with a box-type dryer based on a convective heat transfer system at a drying temperature of from 40 to 120° C.

(11) The drying method according to any one of (6) to (8) wherein said drying method is implemented with a drum dryer based on a conductive heating system with a drum surface temperature in said dryer of 40 to 120° C.

(12) The drying method according to any of (6) to (8) or (11) wherein said drying method is implemented with a reduced pressure or vacuum drum dryer based on a conductive heating system with a drum surface temperature in said dryer of 40 to 100° C.

(13) The drying method according to any of (6) to (10) wherein said drying method is uniformly implemented so that the temperature of the capsinoid-containing chili peppers and an air discharge temperature of the dryer are maintained at 120° C. or below.

(14) The drying method according to any of (6) to (13) wherein said capsinoid-containing chili peppers are cut to promote moisture evaporation and enhance capsinoid stability.

(15) A capsinoid-containing dried chili pepper product dried by the method according to any one of (6) to (14) in which a capsinoid content of not less than 30 percent of the level preceding drying is maintained.

(16) A capsinoid-containing dried chili pepper product dried by the method according to any one of (6) to (14) in which a capsinoid content of not less than 0.01 mg per gram of dried product is maintained.

The present invention permits the obtaining of a capsinoid-containing dried chili pepper product suited to industrial extraction without loss of the capsinoid components of the capsinoid-containing chili peppers, imparting great industrial utility.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is an example of a box-type batch dryer; and

FIG. 2 is an example of a rotating-type dryer.

### DETAILED DESCRIPTION OF THE PREFERRED EMBODIMENTS

In the present invention, the term “capsinoid” means a fatty acid ester of vanillyl alcohol contained as a component of a non-pungent chili pepper. Typically, the capsinoids include capsiates, dihydrocapsiates, and nordihydrocapsiates. Accordingly, in the present invention, the term “capsinoid-containing chili pepper” includes both the body and fruit of plants of the genus Capsicum containing capsinoid components (referred to as “chili peppers” hereinafter).

The capsinoid-containing chili peppers employed may be derived from local pungent chili pepper species typified by “Nikko,” “Goshiki,” and the like, or may be any other type of chili pepper that contains capsinoids. Of these, local non-pungent species of chili peppers typified by “CH-19 Sweet,” “Manganji,” “Fushimi Amanaga,” “Shishito,” and green peppers containing quantity of capsinoids and may be suitably employed. The non-pungent species “CH-19 Sweet” contains a large quantity of such components and is thus employed with particular preference. Here, the term “CH-19 Sweet” is to be construed as including both “CH-19 Sweet” and later generation analog species of “CH-19 Sweet”. In the present Specification, the term “CH-19 Sweet” refers to such species collectively.

Methods of drying capsinoid-containing chili peppers are described below.

1. Drying System:

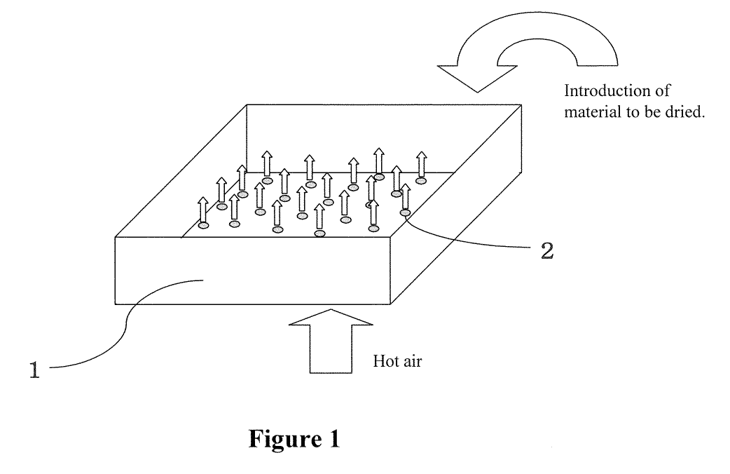

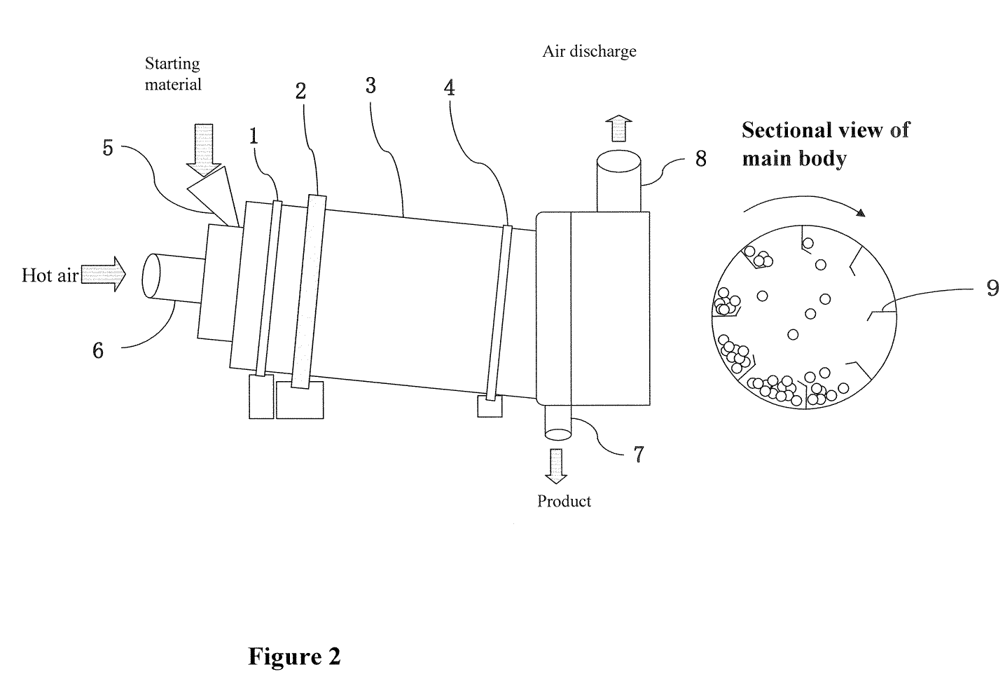

Industrial devices for drying solid and powder products include box-type, tunnel-type, band-type, hard-type, rotating-type fluid, ventilated rotating, draft, cylinder stirring, vacuum rotating, far infrared, microwave, inductive heating, and hot steam drying methods. The use of spraying-type and drum dryers is known in drying systems for liquids, mud, silt, colloids, oils, mixed solutions of finely comminuted products, and the like. Additionally, supercritical drying systems and the like have been developed (see, Powder Engineering Handbook, 2^{nd} ed., comp. by the Japan Society of Powder Technology, p. 358.). These dryers may be roughly divided by heat transfer method into convective heat transfer, conductive heating, and radiative heat transfer systems. Convective heat transfer systems, also known as draft heating systems, are hot drying methods in which hot air is passed directly over the surface or through a layer of the material being dried and heat is transferred by convection. There are many examples of such systems among the above-mentioned box-type, tunnel-type, band-type, and rotating-type dryers. Conductive heating systems are drying methods in which a material being dried is supported on, or passed through, the surface of a heating medium and heated by thermal conduction. There are many examples of such systems among the above-mentioned drum-shaped and spraying-type dryers. Radiative heat transfer systems are dryers employing a source of heat in the form of infrared radiation, high-frequency waves, or microwaves. Any of the above may be employed in the drying of the capsinoid-containing chili peppers of the present invention (referred to hereinafter simply as “chili pepper mass”) so long as the dryer confirms to the drying conditions described further below. From the perspective of universality, convective heat-transfer system box-type, tunnel-type, band-type, rotating-type fluid, and cylindrical stirring systems, as well as drum-type convective heating systems, are preferred. From the perspective of the stirring conditions described further below, band-type, rotating-type fluid, and cylindrical stirring systems are preferred. FIG. 1 shows a typical example of a box-type batch device, and FIG. 2 shows a typical example of a rotating-type fluid device. The present invention is not limited thereto.

In FIG. 1, reference numeral 1 indicates the dryer main body, and reference numeral 2 indicates a punched hole (hot air outlets). In FIG. 2, reference numeral 1 indicates a support roller, reference numeral 2 indicates a drive roller, reference numeral 3 indicates the dryer main body, reference numeral 4 indicates a support roller, reference numeral 5 indicates a starting material inlet, reference numeral 6 indicates a hot air inlet, reference numeral 7 indicates a product removal outlet, reference numeral 8 indicates an air discharge outlet, and reference numeral 9 indicates a lifting plate.

Further, when the chili pepper mass is cut for drying, devices known for use in drying products varying from solids to powders can be employed as the drying system. Alternatively, the chili pepper mass can be subjected to a suitable pretreatment such as extremely fine cutting (mincing) or dispersion in a solvent (referred to hereinafter as a “chili pepper mass solution”) and a device (such as a drum dryer) known for drying liquids, mud, silt, colloids, oils, or mixed solutions of finely comminuted product may be employed. Further, drying can be conducted with the interior of the device under vacuum or reduced pressure, the air employed in drying can be dehumidified for use, or drying can be conducted in a chamber in a dehumidified environment to conduct drying at lower temperature. In this case, a vacuum drum-type dryer is particularly desirable among the drum dryers. Here, the term “vacuum drum dryer” refers to a drum-type dryer with a vacuum chamber that is capable of drying mixed chili pepper solutions at reduced pressure (including under vacuum) and at low temperature. Vacuum drum dryers may be devices that dry a chili pepper mass on a drum having a chamber the pressure of which can be reduced. Known methods as well as vacuum drum dryers developed in the future may be employed (see, for example, Japanese Patent Application Publication Nos. Heisei 7-8702 and Heisei 7-51502).

2. Drying Conditions:

1) Drying Conditions and Capsinoid Survival Rate

The present inventors conducted extensive research, resulting in the discovery that the capsinoid survival rate was related to the drying conditions as follows. They discovered that when the chili pepper mass was cut, either ahead of time or during drying, and then supplied to a (continued) drying step, the surface area increased and the outer skin of the chili peppers ruptured, accelerating moisture evaporation, enhancing drying efficiency, and permitting rapid drying. Further, increasing the speed of the air in portions in contact with the chili pepper mass enhanced moisture evaporation and prevented uneven heating, thereby further contributing to rapid drying and greatly increasing the capsinoid survival rate. Further, combining frequent and uniform mixing and stirring reduced uneven heating of the chili pepper mass. As a result, water evaporated uniformly from the chili pepper mass. In this process, the heat of vaporization prevented a rise in the product temperature. Subsequently, overheating of capsinoid components was prevented, and decomposition of capsinoid compounds in the drying step was suitably prevented.

2) Temperature Conditions

(1) Temperature Conditions when Employing a Convective Heat Transfer Dryer

Accordingly, to increase the capsinoid survival rate follow drying of capsinoid-containing chili peppers when employing a convective heat transfer dryer, the temperature of the hot air blown in during drying is desirably set to 30 to 120° C., preferably 40 to 120° C., still more preferably 50 to 100° C., still more preferably 50 to 80° C., and still more preferably 70 to 75° C. When this is done, the discharge air temperature of the dryer is desirably maintained at 120° C. or less under uniform temperature conditions. When a dryer equipped with a rotating-type flow mechanism or cylindrical stirring mechanism is employed and the starting material is vigorously or frequently stirred, uneven heating is prevented by the stirring and a rise in the temperature of the product is effectively precluded, permitting the use of a higher temperature. Additionally, under conditions where dehumidified hot air is supplied—for example, when a blowing mechanism equipped with a dehumidifying device or a dryer equipped with a dehumidifying device is employed—drying at still lower temperature is possible. When determining the drying time, a suitable preliminary investigation can be conducted and the time required to achieve the moisture level described further below can be set in relation to the quantity of hot pepper loaded and the capacity of the machine in addition to the above hot air temperature. That is, drying until the moisture content reaches 10 percent or less, preferably 5 percent or less, enhances the extraction efficiency of the organic solvent extraction or oil extraction step following drying and prevents rotting during storage. In addition it reduces the free water in the chili pepper mass, thereby increasing the stability of the capsinoids. Accordingly, drying until the moisture content reaches 10 percent or less, preferably 5 percent or less, is important for increasing capsinoid stability. The moisture content is desirably measured by the AOAC method, a standard international method. However, for the sake of process management, other convenient methods may also be employed. When drying is conducted until the moisture content reaches 10 percent or less, the weight of the chili pepper mass decreases to about 20 percent the pre-drying level.

(2) Temperature Conditions when Employing a Drum Dryer

To increase the survival rate of capsinoids following drying of the capsinoid-containing chili peppers, the temperature of the surface of the drum during drying with a drum dryer is desirably 30 to 120° C., preferably 30 to 100° C., and more preferably 30 to 90° C. Further, when employing a vacuum drum dryer equipped with vacuum chamber, the pressure in the vacuum chamber is desirably no higher than 100 Torr, preferably no higher than 50 Torr, more preferably no higher than 30 Torr, and still more preferably no higher than 10 Torr. Such conditions can be suitably set based on the machine. For example, conditions permitting drying that maintains the flavor of seasonings can be employed (see, e.g., Japanese Patent Application Publication No. 2000-41613).

Further, as stated above, rendering the internal temperature of the capsinoid-containing chili peppers uniform during drying increases the capsinoid survival rate following drying. Thus, uneven heating during drying is desirably actively prevented. To prevent uneven heating, it is important to prevent overheating following the completion of evaporation of moisture in the capsinoid-containing chili peppers. From this perspective, it is desirable to suitably alter the heating temperature and period. For example, to conduct two-stage drying, in which lowering the drying temperature or ventilation air applied so that altering the temperature be lower from several minutes to several hours before the moisture content of the capsinoid-containing chili peppers reaches 10 percent or less, regular sampling can be conducted and the moisture content of the product being dried can be suitably measured, or a temperature sensor can be employed in the dryer. This effectively prevents overheating, increasing the capsinoid survival rate. Further, when conducting low temperature drying from the outset, the temperature remains low even when heating is uneven, having little effect on the capsinoid survival rate. From this perspective, the above-described vacuum drum dryer or dryer equipped with dehumidifying device is desirably employed.

3) Preprocessing of the Product Being Dried

In another method of preventing uneven heating, the capsinoid-containing chili peppers can be suitably cut prior to the drying step. The cutting size is suitably determined for each dryer employed. That is, a size that prevents loss of the product due to the product falling into the dryer and optimizes stirring efficiency can be employed. When cutting to a size smaller than the outlets of the hot air nozzles, it is possible to employ a cloth or the like of suitable mesh size to prevent leaks from the drum. As an example, when employing a box-type batch dryer, the cutting size is desirably 0.1 mm to 10 cm, preferably 0.7 mm to 5 cm, more preferably 0.5 mm to 10 mm. A slicer, mincer, power mill, or the like can be suitably employed for cutting. When processing on an industrial scale, a slicer is desirable from the perspective of efficiency. When cutting frozen starting materials, it is desirable to employ a device with good dynamic cutting strength and a cutting blade that will not drop out.

4) Stirring Conditions

To prevent the above-described uneven heating, it is important to set stirring conditions. In the example of a box-type batch dryer, when charged with 100 kg of a frozen, comminuted starting material and employing a hot air inlet temperature of 70° C., stirring once each 30 minutes as opposed to once each hour reduced the drying time from 3.5 hours to 2.5 hours and increased the capsinoid survival rate from 41 percent to 58 percent. Accordingly, frequent stirring is desirable during drying. Specifically, when employing a box-type batch dryer, stirring once each 30 minutes is desirable, once each 15 minutes is preferred, and continuous stirring is of even greater preference. Further, it is possible to mount a suitable stirring device to conduct continuous stirring, even on a batch-type device. When conducting drying with the above-described rotating-type dryer, intermittent stirring is highly desirable. With a band-type dryer, when the belt mechanism rotates, the product being dried is sometimes transferred to the next belt mechanism and stirred. In that case, the degree of uneven heating varies with the quantity of product being dried that piles up on the belt mechanism, sometimes causing the above conditions to vary. As an example, the rotation frequency, that is, the stirring frequency, of the belt mechanism of a band-type dryer varies with the permissible rpm of the machine, but is about once every 30 minutes.

5) Air Flow

Based on the structural formula of capsinoids, it is easy to imagine them hydrolyzing into vanillyl alcohols and fatty acids upon contact with water. It is anticipated that rapidly and efficiently moving the moisture out of a product being dried with hot air can prevent such hydrolysis and greatly improve the survival rate. The transporting of moisture by hot air is affected by the moisture level (saturated water vapor level) that can be carried by the hot air. When the drying temperature is raised, the quantity of water vapor that can be carried by the hot air increases and drying progresses. However, when stirring is infrequent, uneven heating results, overheated portions develop, and the hydrolysis of capsinoids is thought to partially progress. When the drying temperature is low, the amount of water vapor that can be carried by the hot air is lower than when the temperature is high, so drying efficiency decreases. However, the air speed can be increased to frequently bring in hot air that has not reached the water vapor saturation level. This can be expected to increase drying efficiency at low temperature.

Normally, in a batch-type dryer, the speed of the air immediately after passing through the product being dried is also affected by complicating charging of the product being dried, and the value varies with the site of measurement, but is 0 to 0.7 m/s. When the average of measurements taken at several spots is calculated, it is less than 0.2 m/s (to determine the air speed, measurements were taken at several points on the drying surface, and the average value was rounded off to the nearest significant digit). When this device was employed to increase the air speed and increase the speed of the hot air immediately after passing through the product being dried, the average air speed reached or exceed 0.2 m/s. Heating by hot air efficiently moved water vapor evaporating from the product being dried into the hot air. As a result, the heating time was shortened, and the survival rate increased (see, 4 and 6 in Table 1). In this process, when the mixing and stirring frequency was increased, the survival rate climbed even higher (see, segments 2, 5, and 6 in Table 1). Further, drying efficiency also increased when the thickness of the starting material charge layer was reduced at the same air speed. As a result, the survival rate also increased (see, segments 4 and 7 in Table 1). At that time, production efficiency decreased, but production efficiency could be supplemented by employing a dryer conducting continuous charging and drying.

3. Other Steps:

The capsinoid content of the dried product of the present invention obtained by the drying method set forth above can be measured under the analysis conditions described below. Further, the dried product of the present invention contains capsinoids and can be suitably employed to extract capsinoids. To suitably prevent the decomposition of capsinoids after drying so as to increase extraction efficiency, it is desirable to store the dried product in a refrigerator, preferably a freezer. Likewise, the storage of intermediate dried products during drying in a refrigerator or freezer is desirable. Similarly, employing raw fruit in the form of capsinoid-containing chili peppers that have been stored in a refrigerator or freezer prior to drying increases the capsinoid content following drying. In capsinoid extraction, an extraction method such as organic solvent extraction employing hexane, alcohol, liquefied carbon dioxide gas, ethyl acetate, acetone, or the like and oil extraction methods employing primarily edible oils may be suitably employed. In this process, it is also desirable from the perspective of extraction efficiency for the dried product of the present invention to have a moisture content of 10 percent or less.

4. Capsinoid Analysis Methods:

1) A suitable quantity of chili peppers, a dried product thereof, or an intermediate product in the drying process is weighed out and refrigerated.

2) The refrigerated chili peppers, dried product thereof, or intermediate product in the drying process is freeze-dried.

3) When completely dry, the freeze-dried product is comminuted to a degree where it is difficult to distinguish the seeds.

4) After adding an organic solvent to the comminuted product and thoroughly stirring and mixing, centrifugation is conducted and the supernatant is employed as a sample extraction solution.

5) As needed, the sample extraction solution can be purified with Bond Eluate C18 to obtain a bond eluate filtrate.

6) The sample extraction solution and bond eluate filtrate are suitably diluted and quantified by high-performance liquid chromatography (HPLC).

7) Synthesized capsinoid can be employed as standard product.

Capsinoid Survival Rate

The capsinoid content of a sample for which the survival rate was being calculated was measured and the ratio relative to the capsinoid analysis value of the control (same lot, “CH-19 Sweet” frozen product) was calculated as the capsinoid survival rate. Capsinoid survival rate (%)=capsinoid content per gram of sample dried product÷capsinoid content per gram of control dried product×100

HPLC content analysis was conducted according to a method described in the literature (J. Agric. Food Chem., 2001, 49, 4026-4030).

| | |
|---|---|
| Column: | J's sphere ODS-H80 (150 mm × 4.6 mm i.d.) |
| Mobile phase: | 80 percent methanol |
| Flow rate: | 0.5 mL/min |
| Fluorescence detection: | 280 nm, em 320 nm |

5. Moisture Detection Method

1) Moisture Detection During Drying

A Ketto moisture meter (infrared moisture measurement device) was employed. A roughly 5 g sample of CH-19 Sweet for moisture detection was cut to suitable size and charged to a measurement container. The height of the light source was fixed at 7 cm and measurement was conducted until the measured moisture value stabilized. The measurement time was 20 to 25 minutes for the initial drying period sample and about 5 minutes for the final drying period sample.

2) Moisture Measurement in Dried Product (the AOAC Method)

A roughly 10 g sample of CH-19 Sweet for measurement was mixed until uniform. Roughly 3 g quantities of sample were weighed out in scale bottles (three per sample). The weighed sample was dried for four hours at 105° C. in a thermostatic dryer. The weight was measured following drying and the moisture was calculated from the following equation (average value for n=3).
Moisture (%)=moisture evaporation weight (g)÷quantity of CH-19 Sweet employed (g)×100.

Other features of the invention will become apparent in the course of the following descriptions of exemplary embodiments which are given for illustration of the invention and are not intended to be limiting thereof.

### EXAMPLES

In the following examples, unless specifically stated otherwise, the percentages given in the present invention denote weight percentages.

### Example 1

Frozen CH-19 Sweet chili peppers were comminuted to a diameter of 0.7 to 5 mm while still frozen. A 100 or 200 kg quantity was charged to a box-type batch dryer to achieve a starting material layer of about 4 cm.

The temperature of hot air blown into the box-type dryer was set to about 70° C. and the dried product was mixed at a frequency of once each 30 minutes or 60 minutes.

At the end of drying, a Ketto moisture meter (infrared moisture measurement device) was used to check for a standard of 5 percent or less.

Following drying, the chili peppers were comminuted, molded to desired form, and packaged.

The capsinoid content of the dried product was checked as the survival rate relative to the capsinoid content of a dried product obtained by freeze-drying the frozen starting material employed. Table 1 gives the capsinoid survival rate together with the moisture content measured for the dried product. Since there was variation in the content of capsinoids in the chili peppers depending on the starting material, the survival rate was recorded based on the following test.

| | Test segment | | | | | | |
|---|---|---|---|---|---|---|---|
| | Embodiment | Embodiment | Embodiment | Embodiment | Embodiment | Embodiment | Embodiment |
| | 1-1 | 1-2 | 1-3 | 2-1 | 2-2 | 2-3 | 3 |
| System | Batch-type | Batch-type | Batch-type | Batch-type | Batch-type | Batch-type | Continuous |
| Quantity of starting | 100 | 100 | 100 | 100 | 120 | 260 | about 1000 |
| material charged kg/unit | | | | | | | |
| Cutting | no | yes | yes | yes | yes | yes | yes |
| Stirring frequency | once/30 | once/hour | once/30 | once/30 | once/15 | once/30 | average |
| during drying | minutes | | minutes | minutes | minutes | minutes | once/37 |
| | | | | | | | minutes |
| Hot air temperature (inlet) | 70 | 70 | 70 | 70 | 70 | 75 | 70 |
| Average air speed (m/s) | 0.42 | 0.33 | 0.22 | 0.18 | 0.33 | 0.42 | 0.16 |
| Drying time (hours) | 6.5 | 3.5 | 3 | 2.4 | 2.3 | 3 | 3 |
| Thickness of starting | 4 | 4 | 4 | 4 | 4 | 4 | 2.5 |
| material layer (cm) | | | | | | | |
| Capsinoid survival rate (%) | 62 | 41 | 74 | 73 | 90 | 11 | 98 |
| Moisture content of | 8.3 | 3.6 | 6.9 | 6.2 | 6.1 | 5.2 | 2.9 |
| dried product * (%) | | | | | | | |

* AOAC method

As a result, the drying time following cutting was shortened to less than ½ and the capsinoid survival rate increased by 10 percent or more (test segments 1-1, 3). Further, an increase in stirring frequency raised the capsinoid survival rate to 30 percent or more (test segments 1-2, 3). Increases in cutting and stirring frequency were found to reduce uneven heating based on the color of the capsinoid-containing chili peppers (data not given). The fact that uneven heating was prevented indicated that the temperature of the product remained low during drying. Accordingly, when the standard of a moisture content of 10 percent or less was applied, increases in starting material cutting and stirring frequency contributed to the decrease in uneven heating and maintenance of a low product temperature, and were thus found to contribute to an improved capsinoid survival rate.

### Example 2

Frozen CH19-Sweet chili peppers were comminuted to a diameter of 0.7 to 5 mm while in a partially thawed state. A 100 to 300 kg quantity was charged to a box-type batch dryer to achieve a starting material layer of about 4 cm.

Hot air was blown into the box-type dryer. Drying was started when a temperature gage positioned in the dryer indicated a temperature of about 70 to 75° C. The product being dried was mixed every 15 or 30 minutes.

The speed of the blown hot air was mechanically increased or the hot air speed was varied by valve adjustment.

Drying was ended at a moisture content of 5 percent or less as measured by a Ketto moisture meter (infrared moisture measuring device).

Following drying, the chili peppers were comminuted, molded to a desired form, and packaged.

The capsinoid content of the dried product was checked as the survival rate relative to the capsinoid content of a dried product obtained by freeze-drying the frozen starting material employed. Table 1 gives the capsinoid survival rate together with the moisture content measured for the dried product. As a result, an increase in the air speed enhanced the capsinoid survival rate (test segments 2-1, 2). Further, when the air speed was increased, the capsinoid survival rate reached about the same level as when the drying temperature was increased (test segments 2-1, 3).

### Example 3

Frozen CH19-Sweet chili peppers were comminuted to a diameter of 0.7 to 5 mm while in a partially thawed state. A 1,000 kg quantity was charged to a continuous dryer to achieve a starting material layer of about 2 cm.

Hot air was blown into the dryer. Drying was started when a temperature gage positioned in the dryer indicated a temperature of about 70 to 75° C. The dried product was mixed roughly every 30 minutes.

The speed of the blown hot air was mechanically increased or the hot air speed was varied by valve adjustment.

Drying was ended when a moisture content of 5 percent or less was measured by a Ketto moisture meter (infrared moisture measuring device).

Following drying, the chili peppers were comminuted, molded to a desired form, and packaged.

The capsinoid content of the dried product was checked as the survival rate relative to the capsinoid content of a dried product obtained by freeze-drying the frozen starting material employed. The dried product of capsinoid-containing chili peppers obtained by the present invention can be suitably employed in capsinoid extraction and is of great industrial utility.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method for drying a material which comprises capsinoid-containing chili peppers by means of a box-type batch dryer, wherein the capsinoid survival rate following drying is 70 percent or greater, said method comprising:
1) introducing said material to be dried into said dryer so that said material to be dried contacts hot air; and
2) setting an air flow so that an average air speed of hot air immediately after passing through the material to be dried is 0.3 m/s or greater and so that the air speed is such that the material to be dried is not scattered; and conducting drying until a moisture content of said material as measured by AOAC method reaches 10 percent or less.

2. A method for drying a material which comprises capsinoid-containing chili peppers by means of a continuous dryer, wherein the capsinoid survival rate following drying is 70 percent or greater, said method comprising:
1) introducing said material to be dried into said dryer so that said material to be dried contacts hot air; and
2) setting an air flow so that an average air speed of hot air immediately after passing through the material to be dried is 0.2 m/s or greater and so that the air speed is such that the material to be dried is not scattered; and conducting drying until the moisture content of said material as measured by AOAC method reaches 10 percent or less.

3. The method according to claim 1, wherein said drying method satisfies at least one of the following conditions:
1) a hot air temperature of 65 to 80° C.; or
2) stirring conducted at least once per hour.

4. The method according to claim 2, wherein said drying method satisfies at least one of the following conditions:
1) a hot air temperature of 65 to 80° C.;
2) stirring conducted at least once per hour.

5. The method according to claim 1, wherein the material to be dried is sliced to a width of 0.7 mm to 5 cm.

6. The method according to claim 1, wherein said capsinoid-containing chili peppers are one or more selected from the group consisting of Manganji peppers, Shishito peppers, Fushimi Amanaga peppers, and CH-19 Sweet peppers.

7. A method for drying capsinoid-containing chili peppers, wherein heat drying is conducted so that, at a minimum, the weight of said capsinoid-containing chili peppers is reduced to not more than 20 percent, and the moisture content to not more than 10 percent, of that of the raw fruit.

8. The method according to claim 7, wherein said drying is conducted with a dryer having a heat transfer system operating based on a method selected from the group consisting of convective heat transfer, conductive heating, and radiative heat transfer, or a combination of such methods, and wherein said dryer operates continuously or in batches.

9. The method according to claim 8, wherein said dryer is classified as a band-type, fluidized bed-type, draft-type, rotating-type, spraying-type, stirring-type, box-type, moving bed-type, or drum-type dryer based on the mechanical configuration thereof.

10. The method according to claim 7, wherein said drying is implemented with a convective heat-transfer type dryer and either continuous or discontinuous stirring is conducted at least once an hour.

11. The method according to claim 7, wherein said drying is implemented with a box-type dryer based on a convective heat transfer system at a drying temperature of from 40 to 120° C.

12. The method according to claim 7, wherein said drying is implemented with a drum dryer based on a conductive heating system with a drum surface temperature in said dryer of 40 to 120° C.

13. The method according to claim 7, wherein said drying is implemented with a reduced pressure or vacuum drum dryer based on a conductive heating system with a drum surface temperature in said dryer of 40 to 100° C.

14. The method according to claim 7, wherein said drying is uniformly implemented so that the temperature of the capsinoid-containing chili peppers and an air discharge temperature of the dryer are maintained at 120° C. or below.

15. The drying method according to claim 7, wherein said capsinoid-containing chili peppers are cut to promote moisture evaporation and enhance capsinoid stability.

16. A capsinoid-containing dried chili pepper product, prepared by a method according to claim 7, in which a capsinoid content of not less than 30 percent of the level preceding drying is maintained.

17. A capsinoid-containing dried chili pepper product, which is prepared by a method according to claim 7, in which a capsinoid content of not less than 0.01 mg per gram of dried product is maintained.
